(19) United States
(12) Patent Application Publication
(10) Pub. No.: US 2008/0024268 A1
(43) Pub. Date: Jan. 31, 2008

(54) Component authentication for computer systems

(76) Inventors: Hong W. Wong, Portland, OR (US); Wah Yiu Kwong, Beaverton, OR (US); Jason M. Fung, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/486,617

(22) Filed: Jul. 14, 2006

(51) Int. Cl. G05B 19/00

(52) U.S. Cl. 340/5.8; 726/20; 340/572.1; 340/10.51; 713/176; 340/5.26; 700/225; 713/168

(57) ABSTRACT

A radio frequency (RF) tag may be attached to an electronic component in a computer system to enable authentication of the electronic component. A RF reader may receive information stored in the RF tag. An authentication logic coupled to the RF reader may process the received information and compared it with stored information. The received information may include identification of a manufacturer of the electronic component and identification of the RF tag.

### FIELD OF INVENTION

The present invention relates generally to the field of computer design, and more specifically, to techniques for authenticating electronic components in computer systems.

### BACKGROUND

Counterfeit electronic components used in computer systems have caused many problems for computer users as well as computer manufacturers. The counterfeit electronic components may be cheaper than electronic components from authorized manufacturers (or authentic electronic components). The counterfeit electronic components, however, may not include all the functions and safety features associated with the authentic electronic components causing them to be lower in quality and performance. The counterfeit electronic components may also cause compatibility problems causing computer systems to fail. Other problems that may be attributed to counterfeit electronic components include loss of valuable data and productivity. A counterfeit electronic component that is not designed according to the computer manufacturer's specifications may also explode and cause injuries. These factors cause many concerns to the computer manufacturers. They affect support cost which may affect warranty cost to the computer users. When a computer system fails to perform because of a counterfeit electronic component, a user may perceive that the computer system is not reliable and that it does not perform as advertised. This perception may affect the reputation of the computer manufacturers and of the manufacturers of the authentic electronic component.

### BRIEF DESCRIPTION OF THE DRAWINGS

The present invention is illustrated by way of example and not limitation in the accompanying figures in which like references indicate similar elements and in which:

FIG. 1 is a block diagram illustrating an example of a computer system, in accordance with some embodiments.

FIG. 2 is a block diagram that illustrates one example of associating identification information with an electronic component, in accordance with some embodiments.

FIG. 3A illustrates one example of an authentication system, in accordance with some embodiments.

FIG. 3B illustrates an example of information stored in a RFID tag, in accordance with some embodiments.

FIG. 4 is a flow diagram that illustrates one example of a compatibility verification process, in accordance with some embodiments.

FIG. 5 is a block diagram illustrating one example of a process that may be used to authenticate a component, in accordance with some embodiments.

### DETAILED DESCRIPTION

For some embodiments, electronic components used in computer systems may be authenticated using radio frequency identification (RFID). An RFID tag may be attached to the electronic components. An RFID reader in a computer system may be used to read the RFID tags. An electronic component that fails authentication may be a counterfeit electronic component.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

### Computer System

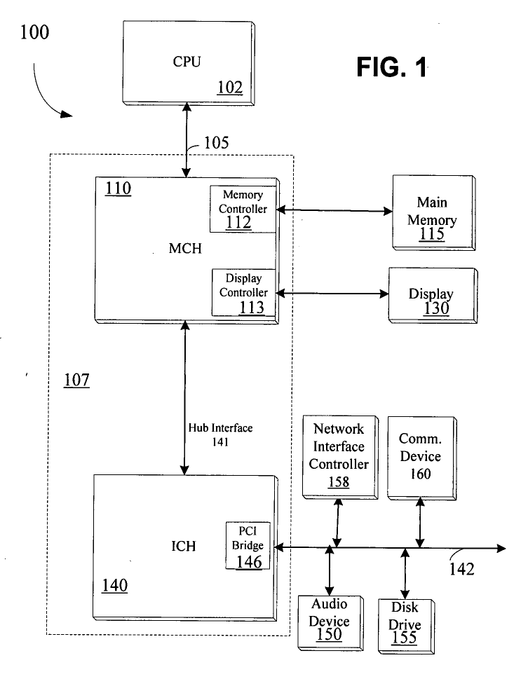

FIG. 1 is a block diagram illustrating an example of a computer system, in accordance with some embodiments. Computer system 100 may be a portable computer system. Computer system 100 may include many electronic components including central processing unit (CPU) 102. CPU 102 may receive its power from an electrical outlet, a battery (not shown), or any other power sources. The CPU 102 and chipset 107 may be coupled to bus 105. The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The MCH 110 may include a display controller 113. Display 130 may be coupled to the display controller 113. The chipset 107 may also include an input/output control hub (ICH) 140. The ICH 140 may be coupled with the MCH 110 via a hub interface 141. The ICH 140 may provide an interface to peripheral devices within the computer system 100. The ICH 140 may include PCI bridge 146 that provides an interface to PCI bus 142. The PCI bridge 146 may provide a data path between the CPU 102 and the peripheral devices. In this example, an audio device 150, a disk drive 155, communication device 160 and network interface controller 158 may be connected to the PCI bus 142. A keyboard (not shown) may be attached to the ICH 140 via an embedded controller (not shown) using the Low Pin Count bus (LPC) or the X-bus (not shown). The disk drive 155 may include a storage media to store data and sequences of instructions that are executed by the CPU 102 or any other processing devices included in the computer system 100. Without techniques to verify authentication, any one or more of the above electronic components may be unknowingly substituted with a counterfeit electronic component.

### Component Detection

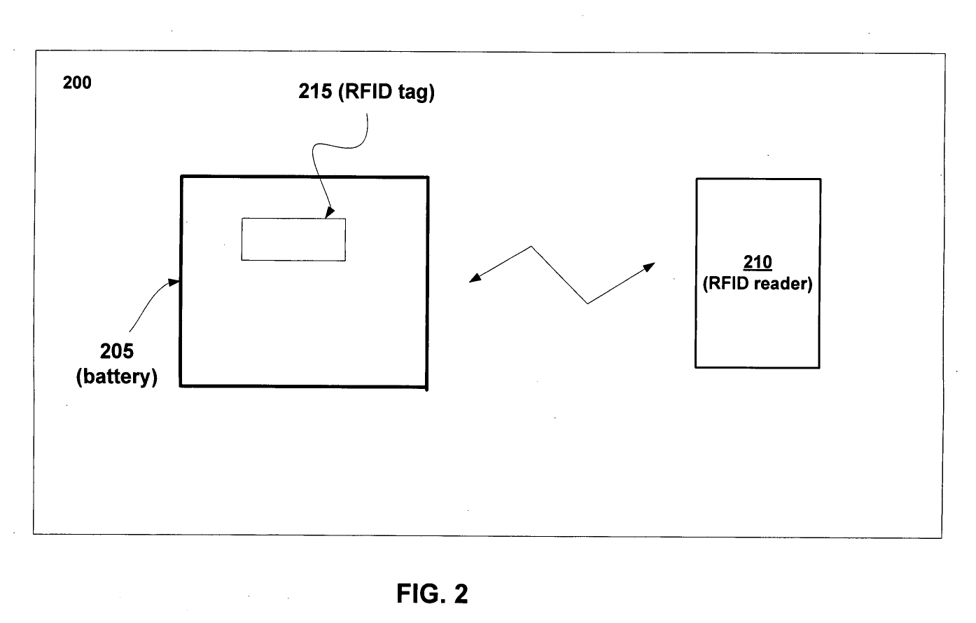

FIG. 2 is a block diagram that illustrates one example of associating identification information with an electronic component, in accordance with some embodiments. Radio Frequency Identification (RFID) is a technique that uses an RFID tag to attach to an object so that the object can be detected. A scanner or RFID reader may be used to read the RFID tag using short wave radio signals. In the current example, RFID tag 215 may be used to detect the presence of the battery 205. The battery 205 may be used as a direct current (DC) power source for computer system 200. The RFID tag 215 may be active or passive. When the RFID tag 215 is active, it may include an internal power source (not shown) and may be able to transmit information to RFID reader 210. When the RFID tag 215 is passive, it may use signals transmitted from the RFID reader 210 to generate sufficient power to transmit the information. Once the information is received by the RFID reader 210, detection of the battery 205 may be established. Other information may also be transmitted from the RFID tag 215 to the RFID reader 210.

The RFID reader 210 may be located on a system board (not shown) in the computer system 200. Alternatively, the RFID reader 210 may be incorporated into other electronic components. For example, an RFID reader may be incorporated into a chipset 107 as illustrated in FIG. 1. An RFID tag may be placed in an area of the component that is protected from being damaged. For example, the RFID tag 215 of, the battery 205 may be placed in a recessed area of its housing (not shown). Using RFID is advantageous because RFID tags may be difficult and costly to counterfeit and therefore may prevent tampering.

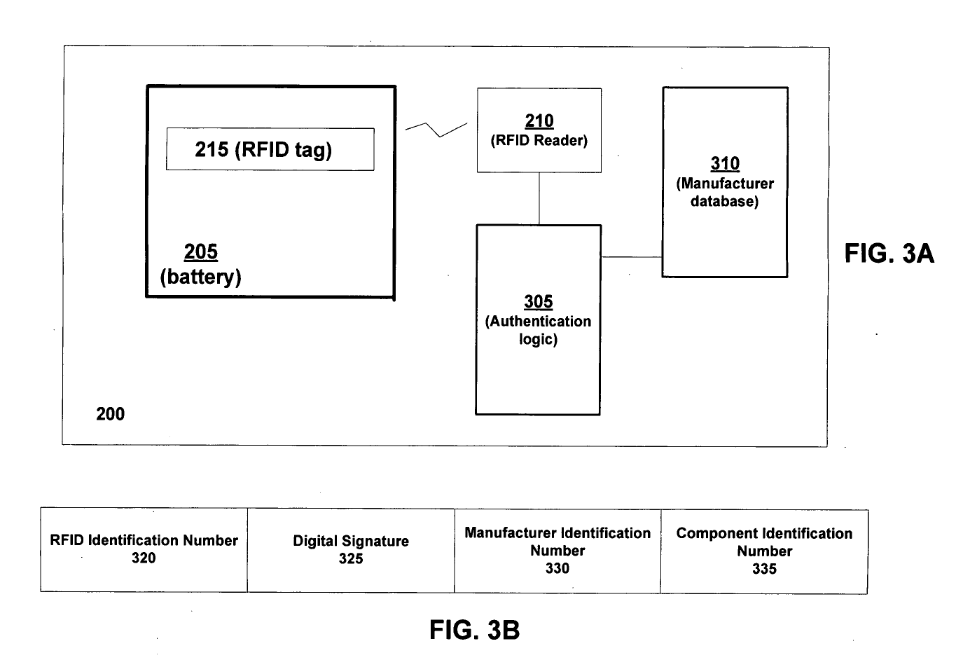

The RFID tag 215 may be provided to a component manufacturer (e.g., battery manufacturer) by an RFID manufacturer. The component manufacturer may be an original design manufacturer (ODM) which manufactures components used in computer systems. For some embodiments, the RFID tag may be preprogrammed with a unique identification number. For example, the identification number of the RFID tag 215 may fall within a certain range assigned specifically to the component manufacturer. Other component manufacturers may purchase RFID tags assigned with other identification number ranges. A component manufacturer may also use its own proprietary identification numbering system to identify a component. The identification of the component may be used for authentication by including it in the information stored in the RFID tag 215, as will be described with FIG. 3B.

### Component Authentication

FIG. 3A illustrates one example of an authentication system, in accordance with some embodiments. One approach to preventing a counterfeit electronic component from being used in a computer system is to perform authentication verification. For some embodiments, authentication logic may be used to process the information received from a RFID tag. The authentication logic may be associated with a RFID reader. For example, to authenticate the battery 205, authentication logic 305 may process information received from the RFID tag 215 by the RFID reader 210. The authentication logic 305 may be implemented in software, hardware or both. The authentication logic 305 may be associated with a controller (not shown).

For some embodiments, the authentication logic 305 may interface with a trusted platform module (TPM) (not shown) to leverage hardware cryptographic support of the TPM. TPM is a specification by the Trusted Computing Group (TCG) that describes storing secured information. A current version of the TPM specification is 1.2 Revision 94, published on Mar. 29, 2006. Two cryptographic techniques may be used to perform the authentication. One technique is asymmetric key cryptography where encryption and decryption are performed using a public and private key pair. The asymmetric key cryptography technique is preferred over symmetric key cryptography so that there is no need to store any secrets in the component (e.g., battery 205) or in the authentication logic 305, hence lowering the exposure of the secrets. For example, the secrets may include any knowledge or information regarding an authentication protocol that is intended only for the component manufacturer to possess, and if it is exposed, may facilitate a hacker to circumvent the authentication system. The secrets may include, for example, secrets keys used in decryption and digital signature creation. Another technique is hashing where a hash may be generated to condense a long string of data bits (e.g., identification number of a component manufacturer and identification of a RFID tag) so that the resulting string can be used to authenticate the component.

Component manufacturer database 310 may include information about authorized component manufacturers. For example, this information for a component manufacturer may include a public key, a unique component manufacturer identification number, range of RFID identification numbers that is associated with the component manufacturer, etc. Other information may also be stored in the component manufacturer database 310 to facilitate the authentication of electronic components from the authorized component manufacturers. In order to keep the component manufacturers' information up to date, the component manufacturer database 310 may need to be updated periodically. The update may be performed via an authorized center or secured download using the Internet. Other update techniques may also be used. For some embodiments, the component manufacturer database 310 and its content may need to be protected from tampering. This may be achieved using, for example, digital signature, hardware protection, etc. Using private key, public key, and digital signature for authentication is known to one skilled in the art.

Referring to FIG. 3A, the authentication of the battery 205 may be performed when the battery 205 is first installed into the computer system 200. The authentication of the battery 205 may also be performed periodically to prevent subsequent installation of a counterfeit battery. The authentication period may be randomized and may not need to be constant. The frequency and associated policy of authentication may be determined by the computer manufacturers. For some embodiments, the authentication logic 305 may perform its authentication without requiring an operating system (OS) to be activated when Active Management Technology (AMT) is used. AMT is a technology developed by Intel Corporation of Santa Clara, Calif. AMT enables management of computer systems even when the computer systems are powered down, the OS has locked up or the disk drive has crashed. AMT is known to one skilled in the art.

FIG. 3B illustrates an example of information stored in a RFID tag, in accordance with some embodiments. For some embodiments, the unique identification number of RFID tag and the identification number of the component manufacturer may be used to authenticate the component. For example, the two identification numbers may be concatenated with one another to form a sequence of numbers. A hash function may be applied to the sequence of numbers to generate a hash value. The hash value may then be digitally signed or encrypted using a secret private key of the component manufacturer to generate a digital signature 325. Using the identification number of the RFID tag 215 and the identification of the component manufacturer to form the digital signature 325 may provide an additional security measure against counterfeiters removing the RFID tag 215 and attaching it to a counterfeit component. Other information may also be used to generate the hash value. For some embodiments, the identification of the RFID tag 320 and any information associated with the component (e.g., the component manufacturer identification number 330 or the identification number of the component 335) may be digitally signed for authentication.

For some embodiments, multiple component manufacturer identification numbers may be assigned to a component manufacturer. The component manufacturer may then use one component manufacturer identification number for one product/component line and another component manufacturer identification number for another product/component line. The component manufacturer may then use a different secret private key for each of the component manufacturer identification numbers. In the event of a leaked secret private key, only one product/component line may be affected. When the digital signature 325 is formed using the identification number of the component 335, the digital signature 325 may also be used by the authentication logic to identify the component manufacturer. For example, the identification number of the component 335 may include a component manufacturer code.

### Performance Verification

The authentication techniques described above are based on information transmitted by the RFID tag 215. For some embodiments, component authentication may further be performed by verifying performance of the component. For example, the authentication logic may cause the component to perform a set of functional tests to determine if the component is capable of delivering expected results.

### Compatibility Verification

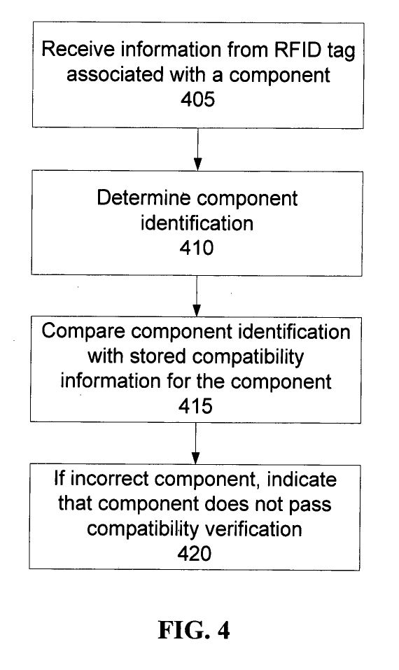

In some situations, it may be desirable to have certain components be compatible with one another. For example, a group of different components from the same component manufacturer may be designed to work together to provide better performance than similar components from different component manufacturers. For some embodiments, the authentication logic may also perform compatibility verification of a component. The compatibility information may be stored and may be used by the authentication logic. FIG. 4 is a flow diagram that illustrates one example of a compatibility verification process, in accordance with some embodiments. At block 405, the authentication logic receives information from the RFID tag associated with the component. At block 410, information about the component is determined. For example, a component type (e.g., battery, hard disk, etc.) may be determined from the identification of the component transmitted by the RFID tag. At block 415, the authentication logic may access the stored information to determine compatibility. For example, the stored information may indicate that this type of component needs to be a particular model number from a particular component manufacturer to pass the compatibility test.

For some embodiments, the information transmitted by the RFID tag may include a compatibility code. The authentication logic may use the compatibility code and compare it with the stored compatibility information to confirm. At block 420, if the component does not pass the compatibility verification, a warning message may be generated. In the example when the component is a battery, the authentication logic may disable the battery or cause it to not be charged if the battery is found to fail the compatibility verification.

### Authentication Process

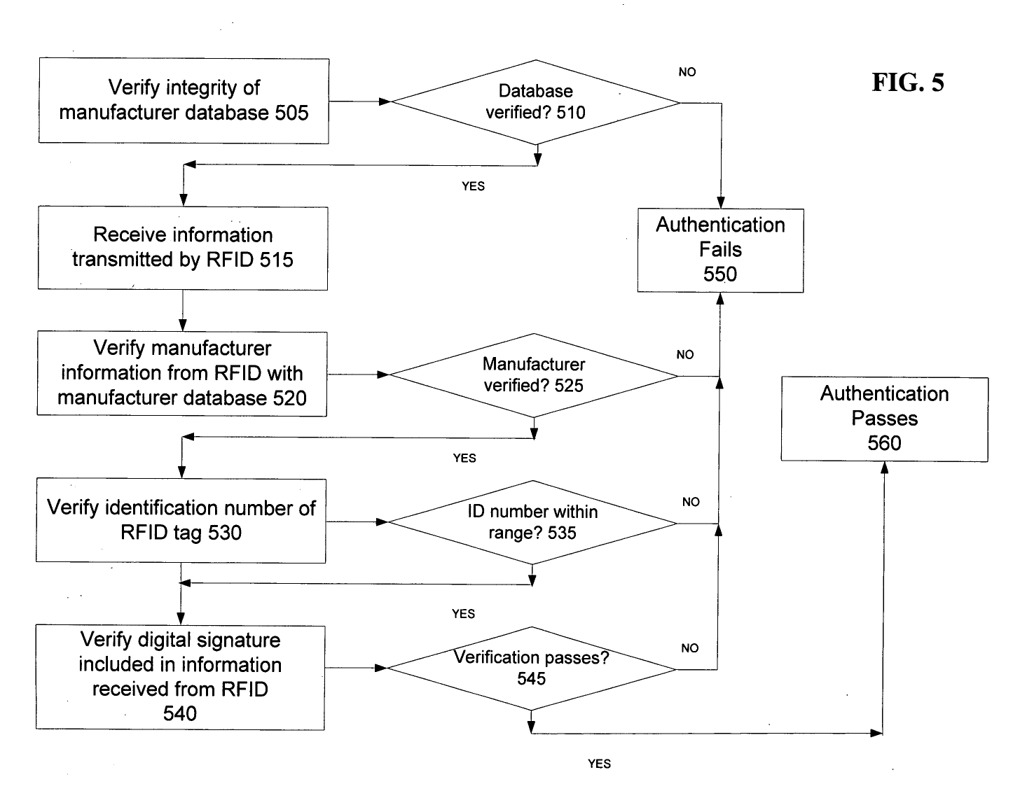

FIG. 5 is a block diagram illustrating one example of a process that may be used to authenticate a component, in accordance with some embodiments. The process may be implemented as a sequence of instructions stored in a storage media and executed by a processor in a computer system. It may also be implemented in hardware or a mixed of software and hardware. The process may be performed by the authentication logic described above. At block 505, the integrity of the manufacturer database is verified. At block 510, if it is determined that the manufacturer database may have been tampered with, the process may flow to block 550 where a warning message may be generated to indicate that the authentication fails.

From block 510, if the component manufacturer database is not tampered with, the process flows to block 515 where information from an RFID tag is received. At block 520, the component manufacturer information received from the RFID tag may be verified with information in the manufacturer database. For example, this verification may be necessary to separate authorized component manufacturers from unauthorized component manufacturers. At block 525, if the component manufacturer is not verified, the process may flow to block 550 and the authentication fails.

When the component manufacturer is verified, the process may flow to block 530 where the identification of the RFID tag is verified. As described above, the identification of an RFID tag from a particular component manufacturer may be within a particular range. If the identification of the RFID tag is not in the range that is expected for the specified component manufacturer, then it is possible that the RFID tag or the component is a counterfeit. At block 535, if the identification is not within the expected range, the process may flow to block 550 and the authentication fails.

When it is within the range, the process may flow to block 540 where verification of digital signature on the RFID tag may be performed. The verification information may include the RFID identification number and component manufacturer identification number on the RFID tag. The verification may be performed using the component manufacturer's public key as stored in the component manufacturer database. At block 545, if the digital signature verification passes, the process may flow to block 560, and the component may be considered to have been authenticated. If the digital signature verification does not pass, the process may flow to block 550, and the authentication of the component fails.

It may be noted that, although the techniques described refer to using RFID technology, other techniques that enable detection of components using short range communication protocol may also be used. For example, techniques that implement short range wireless connectivity to enable simple communications among electronic components may be used. One such technique that may be used is near field communication (NFC). NFC is a standard based technology known to one skilled in the art.

Although some embodiments of the present invention have been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method, comprising:
attaching a radio frequency (RF) tag to an electronic component to be used in a computer system, the RF tag programmed with information which includes at least information about the electronic component and information about the RF tag;
receiving the information programmed on the RF tag via a RF reader; and
authenticating the electronic component by comparing the received information with stored information, wherein the stored information is to include information associated with manufacturers of electronic components.

2. The method of claim 1, wherein the information about the electronic component includes identification of the electronic component and identification the associated component manufacturer, wherein the information about the RF tag includes identification of the RF tag.

3. The method of claim 2, wherein the identification of the RF tag is to be within a range assigned to the component manufacturer.

4. The method of claim 3, wherein the identification of the RF tag and the identification of the electronic component or the identification of the component manufacturer are to be signed using a private key associated with the component manufacturer forming a digital signature, wherein the digital signature is to be programmed in the RF tag and received by the RF reader.

5. The method of claim 4, further comprising authenticating the stored information.

6. The method of claim 5, wherein comparing the received information with the stored information comprises:
verifying that the component manufacturer is valid; and
when the component manufacturer is verified as valid, verifying that the identification of the RF tag is within the range assigned to the component manufacturer.

7. The method of claim 6, further comprising:
verifying the digital signature using a public key associated with the component manufacturer, wherein the public key is included in the stored information.

8. The method of claim 7, further comprising:
verifying that the electronic component is a compatible electronic component according to compatibility information included in the stored information.

9. The method of claim 1, wherein the information programmed on the RF tag does not include any secret information to be used to authenticate the electronic component other than the information about the electronic component and the information about the RF tag, and wherein authentication of the electronic component is performed on a random basis.

10. An apparatus, comprising:
a radio frequency (RF) tag coupled to a first electronic component to be used in a computer system;
a RF reader coupled to the RF tag and configured to receive information stored in the
RF tag, wherein the information is to include information about the first electronic component and information about the RF tag;
a database configured to store information associated with component manufacturers; and
an authentication logic configured to compare the information received by the RF reader and the information stored in the database to authenticate the first electronic component.

11. The apparatus of claim 10, wherein the information about the first electronic component includes identification of the first electronic component and identification of the associated first component manufacturer, wherein the information about the RF tag includes identification of the RF tag.

12. The apparatus of claim 11, wherein the authentication logic is to determine if the first component manufacturer is included in the database.

13. The apparatus of claim 12, wherein the information stored in the RF tag includes a digital signature generated using a private key of the first component manufacturer.

14. The apparatus of claim 13, wherein the database is to store a public key for each of the component manufacturers, and wherein the authentication logic is to verify the digital signature using the public key of the first component manufacturer.

15. The apparatus of claim 14, wherein the authentication logic is to determine if the identification of the RF tag is within a range of RF tag identification numbers assigned to the first component manufacturer.

16. The apparatus of claim 15, wherein the RF tag is implemented using Radio Frequency Identification (RFID).

17. The apparatus of claim 15, wherein the authentication logic receives no secret code from the RF tag to authenticate the first electronic component other than the information about the first electronic component and the information about the RF tag, and wherein the authentication logic is to authenticate the first electronic component on a random basis.

18. A system, comprising:
a radio frequency (RF) reader to receive information transmitted from a RF tag attached to a first electronic component, the RF tag is to store information used to authenticate the first electronic component;
a storage device coupled to the RF reader and configured to store information associated with authorized component manufacturers; and
a controller coupled to the storage device and to the RF reader, wherein the controller is to perform operations to authenticate the first electronic component using the information stored in the RF tag and the information stored in the storage device.

19. The system of claim 18, wherein the information stored in the RF tag includes a digital signature generated using a private key of a manufacturer of the first electronic component, and wherein the controller is to verify the digital signature using a public key of the manufacturer of the first electronic component, the public key stored in the storage device.

20. The system of claim 19, wherein the information stored in the RF tag includes an identification of the RF tag, and wherein the controller is to verify that the identification of the RF tag is within a range assigned to the manufacturer of the first electronic component.

21. The system of claim 20 wherein the information stored in the storage device includes compatibility requirement for one or more components from the authorized component manufacturers, and wherein the controller is to verify if the first electronic component satisfies its compatibility requirement.

22. The system of claim 20, wherein the RF tag is implemented using Near Field Communication (NFC).

23. The system of claim 20, wherein the information stored in the RF tag includes encrypted information and wherein decryption of the encrypted information is performed using logic associated with a trusted platform module (TPM).

24. The system of claim 20, wherein authentication of the first electronic component is implemented using active management technology (AMT).

25. The system of claim 20, wherein authentication of the first electronic component is performed randomly.
